(19) United States
(12) Patent Application Publication
(10) Pub. No.: US 2004/0145299 A1
(43) Pub. Date: Jul. 29, 2004

(54) Line patterned gate structure for a field emission display

(75) Inventors: James Qian Wang, San Diego, CA (US); Benjamin Edward Russ, San Diego, CA (US); Jack Barger, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignees: Sony Corporation, Tokyo (JP); Sony Corporation, Park Ridge, NJ

(21) Appl. No.: 10/350,661

(22) Filed: Jan. 24, 2003

(51) Int. Cl. H01J 1/62; H01J 1/02; H01J 63/04

(52) U.S. Cl. 313/497; 313/309

(57) ABSTRACT

Electron emitting structures and methods of electron emission are provided. In one implementation, an electron emitting structure comprises a substrate, a cathode electrode, an insulating material and a gate electrode. Linear apertures are formed in the gate electrode and in the insulating material in a portion of the gate electrode crossing over the cathode electrode. And an electron emitting material is deposited on a portion of the cathode electrode within each linear aperture. In another implementation, the cathode electrode includes linear cathode sections formed in a portion of the cathode electrode, and the gate electrode has linear gate sections. A respective linear cathode section is located in between two adjacent linear gate sections. And an electron emitting material is deposited on at least a portion of each linear cathode section. In preferred form, the electron emitting structure is implemented in a field emission display (FED).

### BACKGROUND OF THE INVENTION

1. Field of the Invention

The present invention relates generally to flat panel displays (FPDs), and more specifically to field emission displays (FEDs). Even more specifically, the present invention relates to the gate and cathode structure of a field emission display (FED).

2. Discussion of the Related Art

A field emission display (FED) is a low power, flat cathode ray tube type display that uses a matrix-addressed cold cathode to produce light from a screen coated with phosphor materials. A plan view of a cathode plate 10 of a conventional FED is illustrated in FIG. 1 while FIG. 2 shows a cross sectional view of a portion of the cathode plate of FIG. 1 implemented as a conventional FED taken along line 2-2 of FIG. 1. Gate electrodes, e.g., gate electrode 12, cross over cathode electrodes 14 and 16 printed on a substrate 20. The gate electrode 12 is electrically insulated from the cathode electrodes 14 and 16 by a suitable insulating material layer 22 formed therebetween (illustrated in FIG. 2). The gate electrode 12 includes multiple circle apertures 18 (also referred to as emitter wells or holes), which are typically patterned or etched into the gate electrode 12 and insulating layer 22. As shown in FIG. 2, the FED includes the cathode plate 10 and an anode plate 24 (or face plate), which opposes the cathode plate 10. An electron emitter 26 is deposited within each aperture 18, the emitters 26 commonly shaped as conical electron emitters, carbon nanotubes or carbon based emission films.

The anode plate 24 includes a transparent substrate 28 (face plate or display face) upon which is formed various phosphors (e.g., red, green and blue) that oppose the electron emitters 26, for example, phosphor 32 is illustrated. A thin metallic anode 30 is formed over the phosphors, e.g., formed over phosphor 32. Generally, a cathode sub-pixel region 34 is defined as a region of the cathode electrode 14, 16 where electron emitters 26 are deposited within the apertures 18 formed in a gate electrode 12 crossing thereover, whereas an anode sub-pixel region is defined as a portion of the phosphor material 32 oriented to receive the electron emission from emitters 26 of a given cathode sub-pixel region 34.

It is important that the cathode plate 10 and the opposed anode plate 24 be maintained insulated from one another at a relatively small, but uniform distance from one another throughout the full extent of the display face in order to prevent electrical breakdown between the cathode plate and the anode plate, provide a desired thinness, and to provide uniform resolution and brightness. Additionally, in order to allow free flow of electrons from the cathode plate 10 to the phosphors and to prevent chemical contamination, the cathode plate 10 and the anode plate 24 are sealed within a vacuum. In order to maintain a uniform separation between the cathode plate 10 and the anode plate 24 across the dimensions of the FED in the pressure of the vacuum, structurally rigid spacers (not shown) are positioned between the cathode plate 10 and the anode plate 24.

The FED operates by selectively applying a voltage potential between the cathode electrode 16 and the gate electrode 12, producing an electric field to cause a selective electron emission from the electron emitters 26. The emitted electrons are accelerated toward and illuminate the phosphor 32 by applying a proper potential to the anode 30.

Conventional FEDs are known to be difficult to manufacture and typically require a very high electric field to operate; thus, high drive voltages are required at the cathode and gate electrodes. One way to decrease the drive voltage while maintaining a sufficient electric field is to decrease the size or diameter of the apertures 18 (e.g., a diameter of 10 microns). However, as the diameter of the apertures 18 decreases, it becomes increasingly more difficult to uniformly make tiny apertures 18 and to deposit electron emitters 26 into the apertures 18 leading to a more expensive and difficult manufacturing process. Decreasing the diameter may lead to low emission current and higher capacitance.

### SUMMARY OF THE INVENTION

The invention provides an electron emitting structure, used in preferred form as a cathode plate of a field emission display (FED), that has a low drive voltage while having a greater emission, lower capacitance and is easier to produce than conventional FEDs.

In one embodiment, the invention can be characterized as an electron emitting structure comprising a substrate, a cathode electrode formed on the substrate, an insulating material formed on the cathode electrode and a gate electrode formed on the insulating material and crossing over the cathode electrode, the insulating material separating and electrically insulating the cathode electrode and the gate electrode. A plurality of linear apertures are formed in the gate electrode and in the insulating material in a portion of the gate electrode crossing over the cathode electrode, each linear aperture having a width and a length. And an electron emitting material is deposited on a portion of the cathode electrode within each of the plurality of linear apertures.

In another embodiment, the invention can be characterized as a method of electron emission comprising the steps of: applying a voltage potential difference between a cathode electrode formed on a substrate of an electron emitting structure and a gate electrode crossing over the cathode electrode, the cathode electrode and the gate electrode separated and electrically insulated from each other, wherein a plurality of linear apertures are formed in the gate electrode in a portion of the gate electrode crossing over the cathode electrode; producing an electric field across within each of the plurality of linear apertures as a result of the applying the voltage potential difference; and causing, as a result of the producing step, an electron emission from an electron emitting material located within each of the plurality of linear apertures.

In a further embodiment, the invention may be characterized as an electron emitting structure comprising a substrate, a cathode electrode formed on the substrate, the cathode electrode having linear cathode sections formed in a portion of the cathode electrode, and a gate electrode formed on the substrate, the gate electrode electrically insulated from the cathode electrode, the gate electrode having linear gate sections. A respective linear cathode section is located in between two respective adjacent linear gate sections. And, an electron emitting material is deposited on at least a portion of each of the linear cathode sections.

In another embodiment, the invention can be characterized as a method of electron emission comprising the steps of: applying a voltage potential difference between a cathode electrode formed on a substrate of an electron emitting structure and a gate electrode formed on the substrate, the cathode electrode having linear cathode sections formed in a portion of the cathode electrode, the cathode electrode and the gate electrode separated and electrically insulated from each other, the gate electrode having linear gate sections, wherein a linear cathode section is located in between two adjacent linear gate sections; producing an electric field across each linear cathode section in between two adjacent linear gate sections as a result of the applying the voltage potential difference; and causing, as a result of the producing step, an electron emission from an electron emitting material deposited on at least a portion of each of the linear cathode sections.

In a further embodiment, the invention may be characterized as an electron emitting structure comprising a substrate, a cathode electrode formed on a surface of the substrate, and a gate electrode having gate portions formed on the surface of the electrode in a same plane as the cathode electrode. The substrate is electrically insulating the cathode electrode and the gate electrode and an electron emitting material deposited on a portion of the cathode electrode.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a plan view of an electron emitting structure for use in a conventional field emission display (FED) including gate electrodes having circle apertures.

FIG. 2 is a partial cross sectional view of a portion of an FED including the electron emitting structure of FIG. 1 taken along line 2-2 of FIG. 1.

FIG. 3 is a plan view of an electron emitting structure used for example, as a cathode plate of a field emission display (FED), in accordance with an embodiment of the present invention including gate electrodes crossing over cathode electrodes and having linear apertures formed therein.

FIG. 4 is a plan view of the electron emitting structure of FIG. 3 including electron emitting material deposited within the linear apertures on the cathode electrodes.

FIG. 5 is a cross sectional view of an FED using the electron emitting structure of FIGS. 3-4 taken along line 5-5 of FIG. 4 and including an anode plate.

FIG. 6 is another embodiment of the electron emitting structure of FIGS. 3-5 in which linear apertures are broken into linear sections.

FIG. 7 is a plan view of an electron emitting structure used for example, as a cathode plate of an FED, in accordance with another embodiment of the present invention including gate electrodes and cathode electrodes having alternating linear sections formed on the substrate and are in plane relative to each other.

FIG. 8 is a plan view of the electron emitting structure of FIG. 7 including electron emitting material deposited on at least a portion of the linear cathode sections of the cathode electrodes.

FIG. 9 is a cross sectional view of the electron emitting structure of FIG. 8 taken along line 9-9 of FIG. 8.

FIG. 10 is a plan view of one embodiment of the electron emitting structure of FIGS. 7 and 8 illustrating one variation of the gate electrode structure.

Corresponding reference characters indicate corresponding components throughout the several views of the drawings.

### DETAILED DESCRIPTION

The following description is not to be taken in a limiting sense, but is made merely for the purpose of describing the general principles of the preferred embodiments. The scope of the invention should be determined with reference to the claims.

According to several embodiments of the invention, an electron emitting structures, used for example as a cathode plate of a field emission display (FED), are provided that have low drive voltages while having a higher emission current, a lower capacitance and are easier to produce than conventional FEDs having circle apertures. In preferred form, linear apertures or trenches, rather than circular apertures, are formed in each gate electrode while electron emitting material is deposited into the linear apertures. Thus, electron emitting structures in accordance with the invention provide an increased emission area compared to conventional cathode plates of FEDs. Additionally, more electron emitting material results in a greater electron emission and brighter display compared to conventional cathode plates of conventional FEDs. Additionally, in many embodiments, the linear apertures are narrow to provide low drive voltages. Furthermore, the gate electrode material crossing over a given cathode electrode is reduced relative to the circle aperture design; thus, reducing the capacitance generated therebetween.

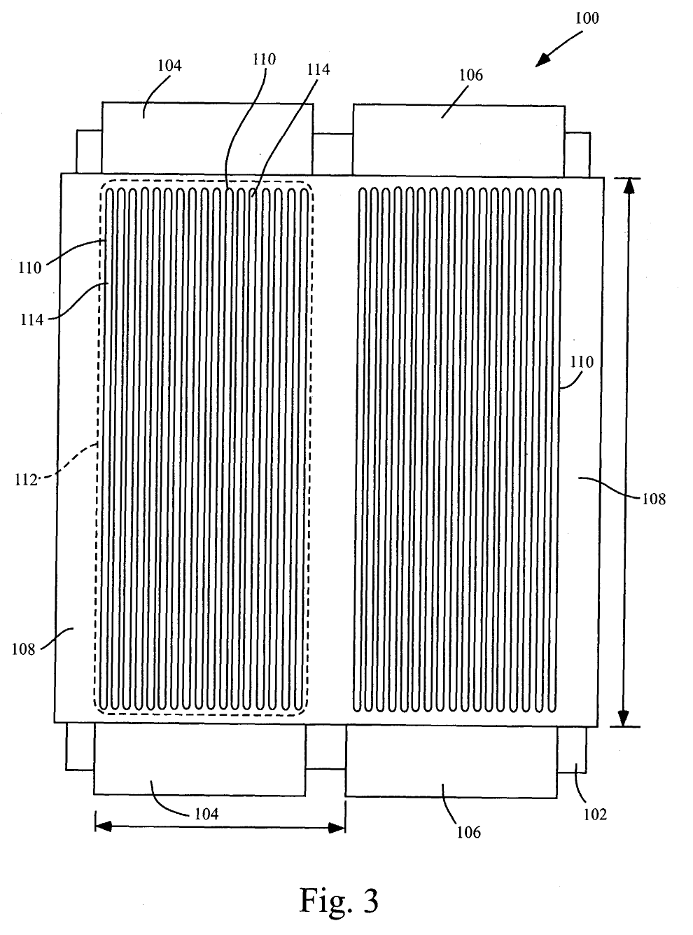

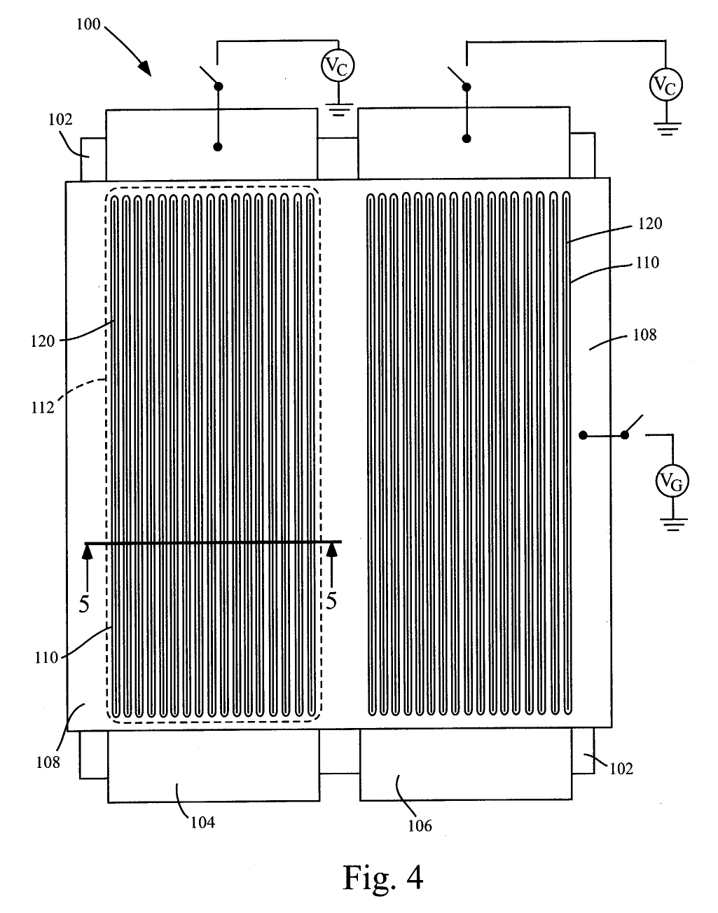

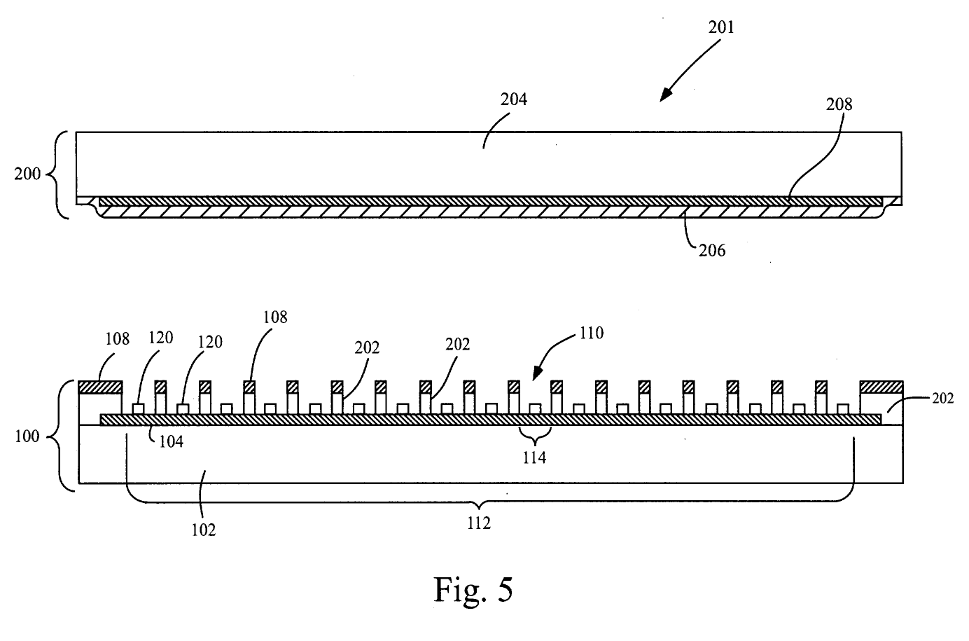

Referring first to FIGS. 3 and 4, plan views are shown of an electron emitting structure used for example, as a cathode plate of a field emission display (FED), in accordance with an embodiment of the present invention. Illustrated is the electron emitting structure 100 or plate including a substrate 102, cathode electrodes 104 and 106 (also referred to as cathodes of an FED) printed on the substrate 102, and a gate electrode 108 (also referred to as a gate of an FED) crossing over the cathode electrodes 104 and 106. The cathode electrodes 104 and 106 are embodied as lines of conductive metallic material. The gate electrode 108 is separated and electrically insulated from the cathode electrodes 104, 106 by a dielectric or insulating material (illustrated in the cross sectional view of FIG. 5) formed on the cathode electrodes 104, 106 and on which the gate electrode 108 is formed over. The gate electrode 108 is preferably embodied as a ribbon or line of conductive material. Additionally, linear apertures 110 are formed in at least a portion of the gate electrode 108 crossing over a respective cathode electrode 104, 106. An active region 112 (also referred to as a sub-pixel region) of each cathode electrode 104, 106 is defined as the area of a given cathode electrode that is formed by the linear apertures 110 formed in a given gate electrode 108 crossing thereover, where electron emitting material may be deposited thereon. It is noted that the portion of the gate electrode 108 having linear apertures 110 formed therein provides a grill-like appearance to the cathode electrode 704, 706.

Although only two cathode electrodes 104, 106 and one gate electrode 108 are illustrated, an electron emitting structure is understood to include many cathode electrodes formed across the substrate 102 and many gate electrodes crossing thereover and separated by a layer of insulating material. As illustrated, preferably, the cathode electrodes 104, 106 extend substantially parallel to each other across the substrate 102. In preferred form, the cathode electrodes 104, 106 form columns extending across the substrate 102. Preferably, the gate electrodes 108 form rows extending across the cathode electrodes 104, 106 and run generally perpendicular thereto.

The linear apertures 110 are formed in at least a portion of the gate electrode 108 that crosses over a respective base electrode 104, 106. However, it is understood that the apertures 110 may be formed over other portions (e.g., an entire gate electrode) of each gate electrode 108 such that some of the apertures 110 are formed on the substrate 102 (i.e., formed to expose portions of the substrate rather than an underlying cathode electrode). Preferably, the linear apertures 110 have a width and length and extend parallel to each other. For example, as illustrated, the linear apertures 110 are extend across the width of the gate electrode 108 and in parallel to each other in the portions of the gate electrode crossing over a given cathode electrode 104, 106. However, it is noted that in alternative embodiments, the linear apertures may extend along at least a portion of the length of the gate electrode (e.g., normal to the orientation of FIGS. 3 and 4). For example, the linear apertures may extend about a portion of the length of the gate electrode 108 crossing over a given cathode electrode 104, 106, or may extend about the length of the gate electrode 108 without breaking in between adjacent cathode electrodes 104, 106. Alternatively, the linear apertures may extend diagonally or at another orientation relative to orientation of the gate electrode 108. Furthermore, although illustrated as having the same width, different linear apertures 110 may have different widths.

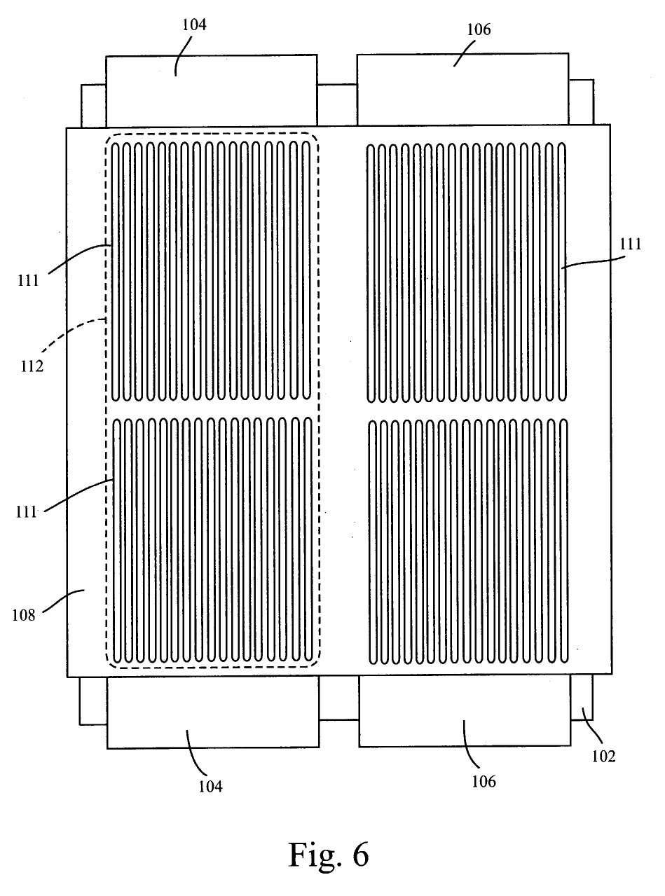

In another alternative illustrated in FIG. 6, a given linear aperture 110 as illustrated in FIG. 3 may be broken into separate linear aperture sections 111. Although FIG. 6 illustrates two linear aperture sections 111 that correspond to a linear aperture 110 of FIG. 3, it is understood that such apertures may be broken into two or more linear aperture sections 111. It is understood that the number of linear aperture sections 111 may depend on a given implementation. However, in generally defining the linear apertures 110 and the linear aperture sections 111 described herein, the linear apertures 110 and the linear aperture sections 111 generally have a width and a length, the length being greater than the width. Preferably, the length is at least 5 times, and more preferably, at least 10 times greater than the width of the given aperture 110, 111.

The linear apertures 110 of a given gate electrode 108 generally define an active region 112 (or cathode sub-pixel region in an FED) of the cathode electrode. Since the each aperture 110 is formed as a trench or chasm etched out of the gate electrode layer and the insulating layer separating the gate electrode 108 from the cathode electrode, the linear apertures 110 expose linear cathode sections 114 of the cathode electrode 104, 106 underneath. The linear cathode sections 114 of a given cathode electrode 104 crossing under a given gate electrode 108 define an active region 112 of the given cathode electrode 104. For example, as illustrated in FIG. 3, the 17 linear cathode sections 114 of cathode electrode 104 defined by the linear apertures 110 of gate electrode 108 formed a given active region 112. The active region 112 is the portion of the cathode electrode upon which electron emitting material is deposited, the electron emitting material designed to emit electrons during operation of the structure 100. In an FED, a grouping of three active regions 112 referred to as cathode sub-pixel regions defines a cathode pixel.

As illustrated in FIG. 4, an electron emitting material 120 is deposited on each linear cathode section 114 of the active region 112 of the cathode electrodes 104, 106. The electron emitting material 120 may be any material that easily emits electrons, for example, a carbon-based material such as carbon nanotubes, carbon graphite or polycrystalline carbon. Additionally, those skilled in the art will recognize that the emitter material 120 may comprise any of a variety of emitting substances, not necessarily carbon-based materials, such as an amorphous silicon materials, for example.

In one embodiment, the emitter material 120 comprises a plurality of discrete electron emitting portions that are deposited within the linear apertures, i.e., are deposited to substantially cover at least a portion of the length of the linear cathode sections 114. For example, the emitter material 120 comprises many tiny emitter cones, single wall or multi-wall nanotubes, or other emitter portions positioned closely together, such that collectively, the many emitter portions form the emitter material 120. For example, known single wall nanotubes have a tube-like structure approximately 1-100 μm tall and 1-7 nm in diameter, while multiwall nanotubes have approximately 1-100 μm tall and 10-100 nm. Many nanotubes are deposited on each cathode linear section 114. Preferably, the nanotubes are spaced about 1-2 μm apart such that the height to spacing ratio is about 1:2. It is noted it is not required that the spacing between nanotubes or emitter cones, or other pieces of discrete emitter portions be consistent. Furthermore, in preferred form, insulating material is not located in between deposited adjacent emitter portions formed on the surface of a given linear cathode section 114.

Furthermore, in some embodiments, rather than comprising a plurality of discrete electron emitting portions, the electron emitting material 120 comprises a layer or thin film of emitting material that is applied along at least a portion of the length of each cathode linear section 114. That is, the electron emitting material 120 is a continuous carbon nanotube film or carbon crystalline film layer (e.g., a coated powder or a deposited film) substantially covering the linear cathode section 114. Such a layer of emitting material may be continuously deposited along at least a portion of the length of the linear cathode section 114 formed within the linear apertures 110. Preferably, the emitter material 120 covers between 25-75%, more preferably, between 45-55%, of the width of the linear cathode section 114.

In operation, each cathode electrode 104, 106 is selectively coupled to a cathode drive voltage V_{C}, e.g., which is controlled via driving/addressing software. Each gate electrode 108 is selectively coupled to a gate drive or gate voltage V_{G}, which is controlled via driving/addressing software. The driving/addressing software uses known row and column addressing and driving techniques. Thus, in the embodiment illustrated in FIG. 4, each of the cathode electrodes 104 and 106 and gate electrodes 108 may be selectably coupled to the respective drive voltages V_{C} and V_{G} (illustrated as switches), while non coupled electrodes are grounded.

In order to cause an electron emission from an emitter material 120 on a respective linear cathode section 114 defined by a respective linear aperture 110, a voltage potential difference (or simply a voltage potential) is selectively applied between a respective cathode electrode 104 and a respective gate electrode 108. For example, in one embodiment, a first voltage potential (e.g., V_{C}) is applied to the respective cathode electrode 104 and a second voltage potential (e.g., V_{G}) is applied to the respective gate electrode 108, such that a voltage potential is applied therebetween. Alternatively, a first voltage potential is applied to one of the respective cathode electrode 104 and the respective gate electrode 108, while the other of the respective cathode electrode 104 and the respective gate electrode 108 is grounded in order to apply the appropriate voltage potential therebetween.

The application of appropriate voltage potential between the respective cathode electrode 104 and the respective gate electrode 108 produces an electric field within the linear apertures 110 across the respective linear cathode sections 114 of the respective cathode electrode 104 that is sufficient to cause an electron emission from the emitter material 120 deposited thereon. In preferred embodiments, through the appropriate width of the linear apertures 110 (e.g., 10 microns) and the selection of emitting materials, such as carbon-based nanotubes, for example, a potential difference of approximately 20 volts between the cathode electrode voltage and the gate electrode voltage will result in an electric field that causes such an electron emission. It is noted that the application of the voltage potential difference between a respective cathode electrode 104 and the respective gate electrode 108 causes an electron emission from the electron emitting material 120 deposited on each of the linear cathode sections 114 formed in each of the linear apertures 110 defining a given active region 116.

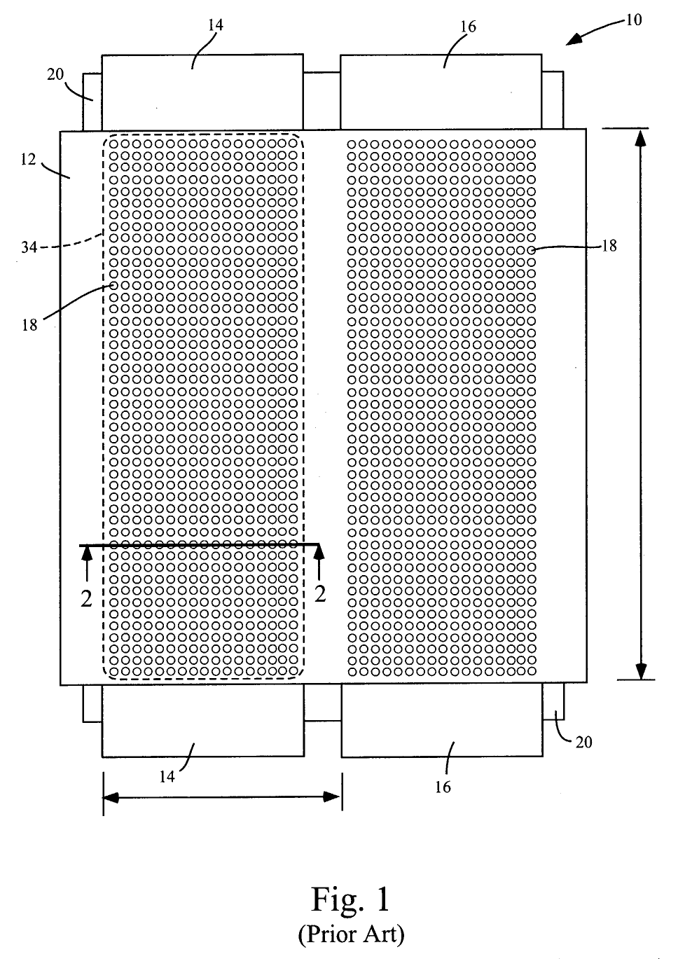

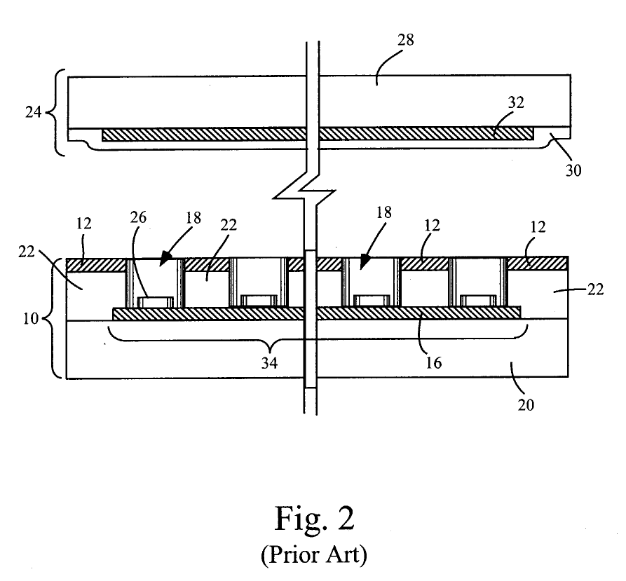

The linear apertures 110 are in contrast to the traditional circle apertures 18 of conventional FEDs, such as illustrated in FIG. 1. Advantageously, by using a line aperture shape, rather than a circle aperture shape, the number of apertures is significantly reduced. For example, in the conventional FED of FIGS. 1 and 2 having a sub-pixel size of 0.32 mm×0.702 mm and circle apertures 18 having a diameter of 10 μm, there are a total of 782 circle apertures 18. In contrast, in the embodiment of FIGS. 3 and 4, having the same sub-pixel size and linear apertures 110 having a width of 10 μm and extending across the width of the gate electrode 108, there are a total of 17 linear apertures 110. This significantly eases the manufacturing process since fewer distinct aperture elements are needed. Apertures are typically manufactured by etching the aperture out of the gate electrode layer and the insulating layer formed in between the gate electrode layer and the cathode electrode. Furthermore, as the size of the apertures is reduced (e.g., the diameter of the circle apertures, and analogously, the width of the linear apertures) in order to reduce the drive voltages used, the circle apertures are increasingly more difficult and expensive to accurately etch. Thus, at these small dimensions, it is easier to etch a linear aperture than a circle aperture.

Additionally, the manufacturing process is simplified since there are fewer emitting elements to deposit (although there is more electron emitting material deposited as described below) compared to the traditional circle aperture design. Defining an electron emitting element as the electron emitting material 120 deposited in a given aperture, in the example above, there are only 17 emitting elements per active region 112 compared to 782 in the traditional circle aperture design. Likewise, from a manufacturing standpoint, it is easier to deposit linear emitting materials (e.g., lines of emitting portions or a continuous layer or film) than to deposit individual tiny emitting portions within separate circle apertures. Furthermore, as the size of the aperture decreases (e.g., the reduce the drive voltage), it is easier to deposit emitter material within a linear aperture 110 than a traditional circle aperture.

Furthermore, the linear aperture 110 exposes more area of the cathode electrode (e.g., linear cathode sections 114) for electron emitting material 120 to be deposited thereon than do conventional circle apertures 18. In the example above, the cathode electrode area available for electron emitting material to be deposited (i.e., cathode sub-pixel region) is increased 380% compared to conventional circle apertures 18.

Since there is more cathode area available for electron emitting material, more electron emitting material may be deposited on an active region than in conventional FEDs. This results in a greater emission of electrons, which when implemented as an FED, results in a brighter display than provided by conventional FEDs.

Additionally, it is understood that an optional resistive layer deposited on the cathode electrode 104 between the cathode electrode 104 and the electron emitting material 120 may be included in the design as is conventionally known. Thus, it is generally noted that the term cathode electrode as used herein may be interpreted to include a resistive layer.

Furthermore, since the linear apertures 110 result in a greater amount of gate electrode material removed (i.e., etched away) than in the traditional circle aperture design, the capacitance generated between a given cathode electrode 104 and a given gate electrode 108 is significantly reduced. In operation, a given cathode electrode and the portion of the gate electrode crossing thereover function as a parallel plate capacitor having a capacitance C generally defined as:

$$C = \frac{K {e}_{0} A}{d} \qquad Eq . ( 1 )$$

where K is the dielectric constant of the insulating material, e₀ is the permeativity of the vacuum within the FED, A is the area of the overlapping interface between the cathode electrode 104 and the gate electrode 108 and d is the distance or separation between the cathode electrode 104 and the gate electrode 108. Assuming that the K, d and e₀ are constant, the linear aperture design results in less gate electrode material that crosses over the cathode electrode 104 in comparison to the circle aperture design of FIGS. 1 and 2. Therefore, since A is reduced, the capacitance C generated between a given cathode electrode and a given gate electrode crossing thereover is reduced compared to that generated in the traditional circle aperture design without affecting the electric field. In the example above, the capacitance C is reduced to 51% of that of the circle aperture design. However, depending on the implementation, the capacitance C may be reduced at least 20%, and more preferably, at least 40%, and most preferably, at least 50% of that of the circle aperture design. Thus, in preferred embodiments, the area A is reduced by at least 20%, more preferably at least 40%, and most preferably by at least 50% in comparison to a circle aperture gate electrode design.

Advantageously, the lower capacitance improves the drive characteristics and allows for more flexibility in the electron emitting structure or cathode design. For example, since the capacitance is lowered, less power is required to charge the cathode electrodes 104, 106 and the gate electrodes 108. That is, since the time constant is lowered, these lines may be charged faster. If, for example, cathode electrodes for 1000 pixels were to be charged, the refresh rate would have to set so that the electrodes (lines) could be charged (i.e., all the pixels could be turned on) or else, electrodes (lines) would be skipped (i.e., some pixels might not be turned on). Thus, according to this embodiment, the refresh frequency may be increased. Alternatively, more pixels may be added to the display for higher resolution, since more pixels may be turned on in less time. Furthermore, by taking less time to turn on a given pixel, the brightness of the device is further improved, since pixels may be left on longer before between refreshing.

Referring to FIG. 5 is a cross sectional view of an FED 201 using the electron emitting structure of FIGS. 3-4 taken along line 5-5 of FIG. 4 and including an anode plate. The cross sectional view clearly illustrates the cathode electrode 104 formed over the substrate 102 and the dielectric or insulating layer 202 formed over the substrate 102 and the cathode electrode 104. The gate electrode 108 is formed over the insulating layer 202. As described above, the linear apertures 110 (the width of which is illustrated) are seen as formed or etched out of the gate electrode layer and the insulating material layer to expose the linear cathode sections 114. Electron emitting material 120 is deposited on each linear cathode section 114 defined by the linear apertures 110. In this embodiment, the active region or cathode sub-pixel region 112 is defined by the linear apertures 110 of the gate electrode 108 crossing thereover. It is noted that an optional resistive layer may be located on the cathode electrode 104 between the cathode electrode 104 and the emitter material 120.

The anode plate 200 is maintained a small and substantially uniform distance above the electron emitting structure 100 (e.g., cathode plate) across the dimensions of the display. The anode plate 200 includes a transparent substrate 204, e.g., a glass substrate. The substrate 204 includes a thin anode material 206 that phosphor 208 is deposited thereon (e.g., in an FED, the phosphor is red, green or blue). Preferably, the phosphor 208 extends linearly about the substrate 204 and runs parallel to the cathode electrode 104 (the cross section of such a phosphor line is illustrated). This gives the FED 201 a SONY® TRINITRON®-like appearance, i.e., the substrate 204 has solid lines of phosphor material (i.e., a striped anode) rather than dots of phosphor materials in traditional pixelized FEDs. However, it is understood that the phosphor 208 could be formed as lines running parallel to the gate electrode 104, or alternatively, the phosphors could be formed as dots or spots rather than lines on the substrate 204 directly above each corresponding sub-pixel region 112. It is also understood that the phosphor material may be directly deposited on the substrate 204 with a thin anode material coating formed thereover. It is noted that a suitable non-transmissive or opaque (black) substance may be applied to the transparent substrate 204 in between respective phosphors.

In operation, by selectively applying a voltage potential difference between a respective cathode electrode 104 and a respective gate electrode 108, an electric field is produced which causes the emitter material 120 deposited in each linear aperture 110 to emit electrons toward and illuminate a corresponding portion (i.e., an anode sub-pixel region) of a corresponding phosphor, e.g., phosphor 208, formed on the anode plate 200 above. Furthermore, as is similarly done in conventional FEDs, in order to accelerate the electron emission toward the phosphor material providing greater brightness of the illuminated anode sub-pixel region of phosphor, a potential is also applied to the anode material 206.

Such an FED 201 may be driven using pulse width modulation techniques as well known in the art in order to vary the brightness of the spot. For example, pulse width modulation varies the duration that a given voltage potential difference is applied between a base electrode 104 and a gate electrode 108 defining a given active region 112 (and thus, a corresponding anode sub-pixel region or “spot”) in order to vary the brightness of the spot.

Furthermore, the FED device incorporates spacers (not shown) that will prevent the anode plate 200 from collapsing on the electron emitting structure 100 in the vacuum. These spacers may be implemented as one or more thin wall segments (e.g., having an aspect ratio of 10-50×1000 μm) evenly spaced across the substrate 102. Additionally, spacers are preferably located in between pixels (a grouping of three sub-pixel regions, e.g., red, green and blue phosphors). Alternatively, these spacers may be implemented as support pillars that are evenly spaced across the substrate 102.

According to preferred embodiments, in addressing and driving the cathode plate 100, a 20 volt potential difference between the cathode drive voltage V_{C} applied to the cathode electrode 104 and the gate voltage V_{G} applied to the gate electrode 108 generates an electric field within each linear aperture 110 across the active region 112 sufficient to create an electron emission. For example, in preferred embodiments, a voltage potential of −10 volts is selectively applied to a respective cathode electrode 104, where an un-energized state of the cathode electrode is at 0 volts. At the same time, a voltage potential of +10 volts is applied to the respective gate electrode 108 crossing over the respective cathode electrode 104, and where an un-energized state of the gate electrode 108 is at 0 volts.

Thus, at different active regions 112 of the electron emitting structure 100, there is a voltage potential difference of either 0 volts (0 volts at the cathode and gate), 10 volts (i.e., −10 volts at the cathode and 0 volts at the gate, or 0 volts at the cathode and +10 volts at the gate) or 20 volts (−10 volts at the cathode and +10 volts at the gate) at the active region 116. In preferred embodiments, the voltage potential difference of 20 volts provides an electric field sufficient to cause an electron emission from the emitter material 120, whereas a voltage difference of 10 volts or 0 volts will not result in a complete electron emission. While the values herein are provided for example, it is understood that the voltage values may be other values or may be DC shifted, for example, the gate voltage may be +40 volts and the cathode electrode drive voltage may be+20 volts relative to +30 volts undriven. Alternatively, a voltage potential may be applied between the cathode electrode and the gate electrodes by applying a voltage potential to one of the cathode electrode and the gate electrodes, while grounding the other one of the cathode electrode and the gate electrodes. It is further understood that the specific voltage levels may be varied according to the specific implementation.

Furthermore, it is understood that varying the width of the linear apertures will vary the drive voltages needed to produce an emission. For example, the narrower the width of the linear aperture, the less drive voltage is required.

The manufacture of the electron emitting structure 100 may be according to well-known semiconductor manufacturing techniques. For example, the cathode electrodes 104, 106 are sputtered on the substrate 102 out of a suitable conducting material, e.g., gold, chrome, molybdenum, platinum, etc. A layer of photosensitive dielectric or insulating material, e.g., ceramic or glass, is then spin coated or formed over the substrate 102 and over portions of the cathode electrodes 104, 106. Next, a layer of conductive gate electrode material is formed over the layer of dielectric material. Then, the gate electrode material layer and the dielectric material layer are patterned using photolithography, for example, and dry etched away to form the gate electrodes 108 having linear apertures 110. The linear apertures 110 are etched from the gate electrode 108 and the insulating layer 202 and expose the linear cathode sections 114. Next, the emitter material 120 is deposited on each linear cathode section 114, e.g., as discrete electron emitting portions or as a continuous layer or film of emitting material.

In a preferred embodiment, the electron emitting structure 100 is implemented as a cathode plate for an FED. For example, the cathode electrodes 104 are each about 0.32 mm wide extending about the substrate 102. Each gate electrode 108 is about 0.702 mm wide extending across the length of at least a portion of the display and crossing over the cathode electrodes 104, 106. Thus, each active region 112 is about 0.32 mm×0.702 mm. The linear apertures 110 are approximately 10 μm wide and extend substantially across at least a portion of the width of the gate electrode 108. The electron emitting material 120 is about 5 μm wide and extends along at least a portion of the length of the linear cathode section 114 formed by the linear aperture 110. It is noted that the dimensions of the various components may be altered depending on the specific implementation without departing from the invention and that the drawings presented herein are not necessarily drawn to scale.

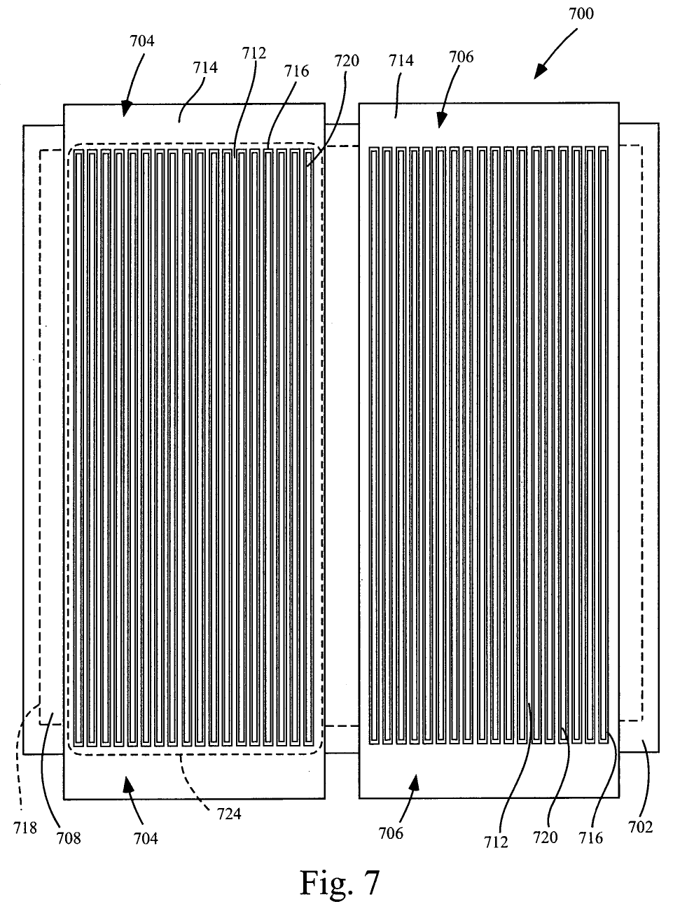

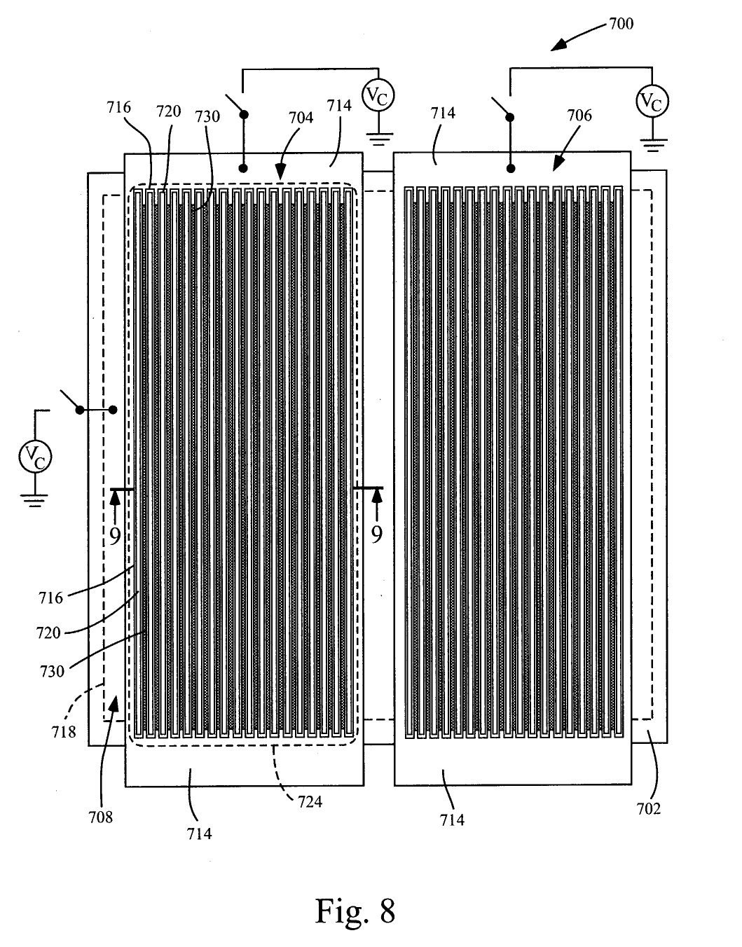

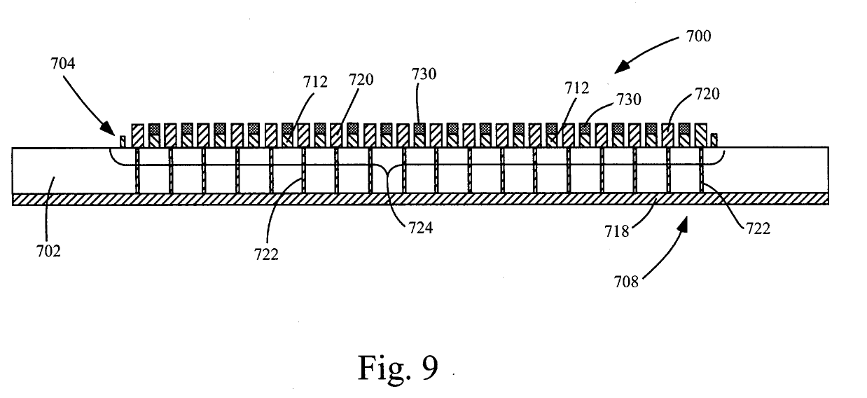

Referring next to FIG. 7, a plan view is shown of an electron emitting structure 700 used for example, as a cathode plate of an FED, in accordance with another embodiment of the present invention including gate electrodes and cathode electrodes having alternating linear sections formed on the surface of the substrate and that are generally in plane relative to each other. FIG. 8 is a plan view of the electron emitting structure of FIG. 7 including electron emitting material deposited on at least a portion of the linear cathode sections of the cathode electrodes. FIG. 9 is a cross sectional view of the electron emitting structure of FIG. 8 taken along line 9-9 of FIG. 8.

Illustrated is the electron emitting structure 700 or plate including a substrate 702, cathode electrodes 704, 706 (also referred to as a cathodes of an FED) printed on the substrate 702, and a gate electrode 708 (also referred to as a gate of an FED) including a back gate section 718 (generically referred to as a gate section) and including linear gate sections 720 (generically referred to as gate portions) which are effectively in plane with the cathode electrodes 704, 706. In this embodiment, the substrate 702 functions as the dielectric material separating and electrically insulating the cathode electrodes 704, 706 from the gate electrode 708.

Each cathode electrode 704, 706 is embodied as a line of conductive metallic material formed on a surface of the substrate 702 extending across the substrate 702. Each cathode electrode 704, 706 includes linear cathode sections 712 extending at least a portion of the length of the cathode electrode, preferably extending a length corresponding generally to the width of the linear gate sections 720. In one embodiment, the linear cathode sections 712 are formed by linear sections 716 that are removed from the cathode electrodes 704, 706. Thus, the linear sections 716 define the linear cathode sections 712. In preferred embodiments, each linear section 716 has an elongated rectangular profile such that the portion of the cathode electrodes having linear cathode sections 712 resembles an aperture grill-like structure. Thus, in preferred embodiments, the linear sections 716 and the linear cathode sections 712 extend parallel to each other.

In manufacture, the cathode electrodes 704, 706 may be screen printed without the linear sections 716 or the linear sections 716 they may be etched away to form the linear cathode sections 712. Alternatively, a conductive layer formed on the substrate 702 is etched to form the cathode electrodes 704, 706 having the linear sections 716. Sets of linear sections 716 defining linear cathode sections 712 are separated from each other along the length of the cathode electrodes by cathode sections 714 (i.e., portions of the cathode electrodes not having linear sections 716 formed therein). Alternatively, the linear sections 716 (and thus, the linear cathode sections 712) may extend along the length of the cathode electrodes such that no cathode sections 714 are present. In this alternative embodiment, the linear gate sections 720 extend a length within the dimensions of a given linear section 716 that generally defines the active region 724, while being spaced apart from adjacent linear gate sections 720 (of other active regions) within the dimensions of the same given linear section 716 by a distance corresponding to the cathode section 714.

The gate electrode 708 includes a back gate section 718 (illustrated in dashed lines in FIGS. 7, 8 and 10) formed on an opposite surface of the substrate 702 as the cathode electrodes 704, 706 and also includes linear gate sections 720 that are formed on the same surface of the substrate 702 as the cathode electrodes 704, 706, but formed within the dimensions of each linear section 716 of each cathode electrode 704, 706. The linear gate sections 720 are positioned within the dimensions or profile of the linear sections 716 such that they do not contact the linear cathode sections 712 or any other portion of the cathode electrodes 704, 706. Thus, a linear gate section 720 is positioned in between adjacent linear cathode sections 712, such that the linear gate sections 720 and the linear cathode sections 712 are alternating. In preferred embodiments, the linear gate sections 720 are parallel to the linear cathode sections 712 and to each other.

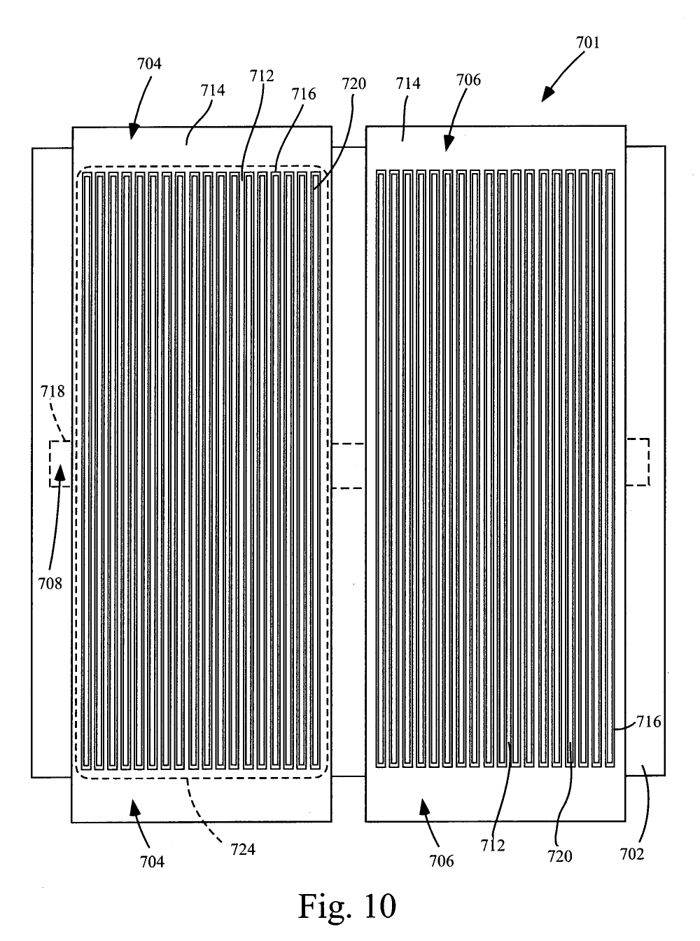

The substrate 702 provides an electrical insulation between the cathode linear sections 712 and the gate linear sections 720 on the surface of the substrate 702. Each linear gate section 720 is coupled to the back gate section 718 via connectors 722 that extend through the substrate 702 (illustrated in FIG. 9). The back gate section 718 is selectively coupled to (thus, the linear gate sections 720 of the gate electrode 708 are selectively coupled to) a gate drive voltage V_{G}. As illustrated in FIGS. 7 and 8, the width of the back gate section 718 is approximately the same as the length of each linear gate section 720; however, it is understood that the width of the back gate section 718 may be independent of the length of the linear gate sections 720, so long as the linear gate sections 720 are electrically coupled to the back gate section 718, e.g., by connectors 722. Thus, in other embodiments, the width of the back gate section 718 is less than the length of the linear gate sections 720 and may be configured as a thin conductive strip, such as illustrated in the electron emitting structure 701 of FIG. 10. As illustrated, the width of the back gate section 718 of FIG. 10 is less than 10% of the length of the linear gate sections 720. It is understood that since the function of the back gate section 718 is to electrically couple the linear gate sections 720 to the gate drive voltage V_{G}, the shaping and dimensions of the back gate section 718 may vary depending on the implementation.

It is noted that in other embodiments, a discrete back gate section 718 may not be required depending on the connector structure coupled to the linear gate sections 712. That is, the linear gate sections 720 may be selectively coupled to the appropriate gate voltage directly via the connectors 722.

It is noted that although the gate electrode 708 is in two planes, i.e., the back and top surfaces of the substrate, in this embodiment, the components functioning as the gate electrode 708 (i.e., the linear gate sections 720) for emission purposes are formed on the same surface of the substrate 702 as the linear cathode sections 712. Thus, the gate electrode 708 and the cathode electrode 704 are formed on the same surface of the substrate 702 and are in plane with each other, while being separated and electrically insulated from one another.

It is also noted that the linear cathode sections 712 and the linear gate sections 720 are illustrated as having a width and a length extending along the length of a given cathode electrode 704, 706. However, it is understood that the linear cathode sections 712 and the linear gate sections 720 may extend across the width of each cathode electrode 704, 706 or otherwise extend diagonally. It is noted that generally the length of the linear cathode sections 712 and the linear gate sections 720 is greater than the width. Preferably, the length is at least 5 times, and more preferably, at least 10 times greater than the width of the given aperture 110, 111.

An active region 724 (also referred to as a sub-pixel region of an FED) of each cathode electrode 704 is defined as the linear cathode sections 712 in between adjacent linear gate sections 720 where electron emitting material 730 may be deposited thereon.

Although only two cathode electrodes 704, 706 and one gate electrode 708 are illustrated, an electron emitting structure is understood to include many cathode electrodes formed across the substrate 702, each cathode electrode having portions including linear sections 716 defining linear cathode sections 712 and also including linear gate sections 720 formed on the substrate 702 within the dimensions of the linear sections 716. Multiple gate electrodes “intersect” or “cross” the cathode electrodes, i.e., the linear gate sections 720 of a given gate electrode 708 located within each linear section 716 of a given cathode electrode. As illustrated, preferably, the cathode electrodes 704, 706 extend substantially parallel to each other across the substrate 702. In preferred form, the cathode electrodes 704, 706 form columns extending across the substrate 702. Preferably, the gate electrodes 708 generally form rows (best illustrated as the dashed back gate sections 718) extending across the cathode electrodes 704, 706 and run generally perpendicular thereto.

The linear cathode sections 712 generally define an active region 724 (or cathode sub-pixel region in an FED) of the cathode electrodes 704, 706. The linear cathode sections 712 are the portion of the cathode electrode upon which electron emitting material 730 is deposited, the electron emitting material designed to emit electrons during operation of the structure 700. Thus, each cathode electrode has many different active regions 724 where different gate electrodes (back gate sections 718 and linear gate sections 720) intersect or cross the cathode electrode. In an FED, a grouping of three active regions referred to as cathode sub-pixel regions defines a cathode pixel.

As illustrated in FIG. 8, the electron emitting material 730 is deposited on at least a portion of each linear cathode section 712 of the active region 724 of the cathode electrodes 704, 706. The electron emitting material 730 may be any material that easily emits electrons, for example, a carbon-based material such as carbon nanotubes, carbon graphite or polycrystalline carbon. Additionally, those skilled in the art will recognize that the emitter material 730 may comprise any of a variety of emitting substances, not necessarily carbon-based materials, such as an amorphous silicon materials, for example.

As described above, the electron emitting material 730 may comprise a plurality of discrete electron emitting portions or a layer or thin film of emitting material that is applied along at least a portion of the length of each cathode linear section 712. Preferably, in this embodiment, the emitter material 730 covers from 20-100% of the width of the linear cathode section 712.

In operation, each cathode electrode 704, 706 is selectively coupled to a cathode drive voltage V_{C}, e.g., which is controlled via driving/addressing software. The linear gate sections 720 of each gate electrode 708 are selectively coupled to a gate drive or gate voltage V_{G} (via the back gate section 718 and the connectors 722), which is controlled via driving/addressing software. The driving/addressing software uses known row and column addressing and driving techniques. Thus, in the embodiment illustrated in FIG. 8, each of the cathode electrodes 704 and 706 and the linear gate sections 720 of each gate electrodes 708 may be selectably coupled to the respective drive voltages V_{C} and V_{G} (illustrated as switches), while non-coupled electrodes are grounded. It is noted that in this embodiment, the gate drive voltage is coupled to the back gate section 718 which is coupled to the linear gate sections 720 via connectors 722.

In order to cause an electron emission from an emitter material 730 on a respective linear cathode section 712 defined by the linear sections 716, a voltage potential difference (or simply a voltage potential) is selectively applied between a respective cathode electrode 704 and a respective gate electrode 708. For example, in one embodiment, a first voltage potential (e.g., V_{C}) is applied to the respective cathode electrode 704 and a second voltage potential (e.g., V_{G}) is applied to the respective gate electrode 708, such that a voltage potential is applied therebetween. Alternatively, a first voltage potential is applied to one of the respective cathode electrode 704 and the respective gate electrode 708, while the other of the respective cathode electrode 704 and the respective gate electrode 708 is grounded in order to apply the appropriate voltage potential therebetween.

The application of appropriate voltage potential between the respective cathode electrode 704 and the respective gate electrode 708 results in a potential applied between adjacent linear cathode sections 712 and linear gate sections 720. This potential produces an electric field across the linear electron emitting material 730 deposited on each linear cathode section 712 in between adjacent pairs of linear gate sections 720 that is sufficient to cause an electron emission from the emitter material 730 deposited thereon. In preferred embodiments, a potential difference of approximately 20 volts between the cathode electrode voltage and the gate electrode voltage will result in an electric field that causes such an electron emission. It is noted that the application of the voltage potential difference between a respective cathode electrode 704 and the respective gate electrode 708 causes an electron emission from the electron emitting material 730 deposited on each of the linear cathode sections 712 defining a given active region 724.

As with the embodiments of FIGS. 3-6, the linear cathode sections and linear emitter material are in contrast to the traditional circle apertures 18 of conventional FEDs, such as illustrated in FIG. 1 and includes many of the same advantages over the traditional design. For example, the number of emitting elements to deposit is reduced, which simplifies the depositing of emitter material in manufacturing. Similarly, the emitter material 730 is deposited as a line which is easier than depositing an emitter within an individual tiny circle aperture. Again, more area of the cathode electrode (linear cathode sections 712) is available for electron emitting material to be deposited than in the conventional circle aperture design. Since there is more cathode area available for electron emitting material, more electron emitting material may be deposited on an active region than in conventional FEDs. This results in a greater emission of electrons, which when implemented as an FED, results in a brighter display than provided by conventional FEDs. Additionally, it is understood that a resistive layer may optionally be formed in between the linear cathode sections 712 and the emitting material 730.

Furthermore, the capacitance generated between the back gate section 718 and the linear cathode sections 712 is less than in the traditional circle aperture design, particularly in the embodiment of FIG. 10, where the back gate section 718 is narrow relative to the active region 724. Referring to Eq. (1) above, since the area A of the overlapping interface between the linear cathode sections 712 and the back gate section 718 is less than the corresponding overlapping area A for a conventional circle aperture design (and assuming similar values for K, d and e₀), the capacitance C generated therebetween is reduced. Again, as described above, the lower capacitance improves the drive characteristics and allows for more flexibility in the electron emitting structure or cathode design.

For example, depending on the implementation (e.g., the dimensions of the back gate section 718 and the linear cathode sections 712), the overlapping area A, and thus the capacitance C, may be reduced at least 20%, and more preferably, at least 40%, and most preferably, at least 50% of that of the circle aperture design. In the embodiment of the FIG. 10, for example, the overlapping area A and the capacitance C are reduced compared to the traditional circle aperture design.

The electron emitting structures 700 and 701 may be substituted for the electron emitting structure 100 of FIG. 5 to implement an FED. Such electron emitting structures 700, 701 would be operated and driven in the same manner as the electron emitting structure 100 of FIG. 5.

The manufacture of the electron emitting structures 700, 701 may be according to well-known printed circuit board technology and semiconductor manufacturing techniques. For example, a substrate 702 is provided that includes connectors 722 manufactured according to known techniques extending from one surface of the substrate to an opposite surface of the substrate 702 with a desired spacing between connectors, the spacing corresponding to a specified distance between linear gate sections 720. A back gate section 718 is sputtered on the back surface of the substrate 702 out of a suitable conducting material, e.g., gold, chrome, molybdenum, platinum, etc., such that the back gate section 718 is coupled to the connectors 722. Alternatively, the back gate sections 718 are etched from a conductive layer applied to the back surface of the substrate 702.

In one embodiment, a conducting layer is then sputtered on a top surface of the substrate 702 out of a suitable conducting material. This conducting layer is then patterned using photolithography, for example, and dry etched away to form the cathode electrodes 704, 706 including linear sections 716 and linear gate sections 720 within the dimensions of the linear sections 716 but not contacting any portion of the cathode electrode 704. The connectors 722 are located such that they are coupled to the etched linear gate sections 720; thus, the linear gate sections 720 are coupled to the back gate section 718 so that they can function as the “gate electrode”. Next, the emitter material 730 is deposited on at least a portion of each linear cathode section 712, e.g., as discrete electron emitting portions or as a continuous layer or film of emitting material.

In a preferred embodiment, the electron emitting structures 700, 701 are implemented as a cathode plate for an FED. For example, the cathode electrodes 704, 706 are each about 0.32 mm wide extending a length about the substrate 102. Each linear section 716 is about 20 μm wide such that each linear cathode section 712 is about 10 μm wide and extends a given length along the cathode electrode. Each linear gate section 720 is about 10 μm wide and extends a given length within the dimensions of the linear section 716. The back gate section 718 of FIGS. 7 and 8 is about 0.702 mm wide extending across the length of at least a portion of the substrate and crossing over or intersecting the cathode electrodes 704, 706; however, as illustrated in FIG. 10, the width of the back gate section 718 may be less than a dimension of the active region 724 (i.e., in FIG. 10, the back gate section 718 is about 50 μm wide extending across the length of the at least a portion of the substrate). Thus, each active region 724 is about 0.32 mm×0.702 mm. The linear cathode sections 712 extend substantially across at least a portion of the width of the gate electrode 708. The electron emitting material 730 is at about 5 μm wide and extends along at least a portion of the length of the linear cathode section 712 formed by the linear sections 716. It is noted that the dimensions of the various components may be altered depending on the specific implementation without departing from the invention and that the drawings presented herein are not necessarily drawn to scale.

While the invention herein disclosed has been described by means of specific embodiments and applications thereof, numerous modifications and variations could be made thereto by those skilled in the art without departing from the scope of the invention set forth in the claims. For example, the electron emitting structures described herein may be implemented as field emission displays (FEDs) or any other application requiring an electron emission that is not necessarily an emission display, such as an imaging device (X-ray device).

What is claimed is:

1. An electron emitting structure comprising:
a substrate;
a cathode electrode formed on the substrate;
an insulating material formed on the cathode electrode;
a gate electrode formed on the insulating material and crossing over the cathode electrode, the insulating material separating and electrically insulating the cathode electrode and the gate electrode;
a plurality of linear apertures formed in the gate electrode and in the insulating material in a portion of the gate electrode crossing over the cathode electrode, each linear aperture having a width and a length; and
an electron emitting material deposited on a portion of the cathode electrode within each of the plurality of linear apertures.

2. The structure of claim 1 wherein upon applying a voltage potential difference between the cathode electrode and the gate electrode, an electric field is produced in each linear aperture sufficient to cause an electron emission from the electron emitting material.

3. The structure of claim 1 wherein upon applying a first voltage potential to the cathode electrode and applying a second voltage potential to the gate electrode, an electric field is produced in each linear aperture sufficient to cause an electron emission from the electron emitting material.

4. The structure of claim 1 wherein the electron emitting material comprises a plurality of electron emitting portions deposited on the portion of the cathode electrode.

5. The structure of claim 1 wherein the electron emitting material comprises a continuous electron emitting material deposited as a layer or film on at least the portion of the cathode electrode.

6. The structure of claim 1 wherein the gate electrode comprises a layer of conductive material formed over the insulating material, the linear apertures etched out of the gate electrode and the insulating material.

7. The structure of claim 1 wherein the length of each of the plurality of linear apertures extends along a width of the gate electrode.

8. The structure of claim 1 wherein the length of each of the plurality of linear apertures extends along a length of the gate electrode.

9. The structure of claim 1 wherein each linear aperture exposes a respective linear cathode section of the cathode electrode, the electron emitting material deposited on the respective linear cathode section.

10. The structure of claim 1 wherein the plurality of linear apertures of the gate electrode result in less capacitance generated between the cathode electrode and the gate electrode relative to a circle aperture design.

11. The structure of claim 1 wherein the plurality of linear apertures expose a greater portion of the cathode electrode for the electron emitting material to be deposited than a circle aperture design.

12. The structure of claim 1 wherein a respective linear aperture is broken into a plurality of linear aperture sections.

13. The structure of claim 1 wherein the plurality of linear apertures define an active region of the cathode electrode.

14. The structure of claim 1 further comprising:
an anode plate comprising:
a transparent substrate separated above the substrate;
phosphor material coupled to the transparent substrate, the phosphor material for receiving electrons emitted from the electron emitting material in use; and
an anode coupled to the phosphor material for accelerating the electrons toward the phosphor material.

15. A method of electron emission comprising:
applying a voltage potential difference between a cathode electrode formed on a substrate of an electron emitting structure and a gate electrode crossing over the cathode electrode, the cathode electrode and the gate electrode separated and electrically insulated from each other, wherein a plurality of linear apertures are formed in the gate electrode in a portion of the gate electrode crossing over the cathode electrode;
producing an electric field across within each of the plurality of linear apertures as a result of the applying the voltage potential difference; and
causing, as a result of the producing step, an electron emission from an electron emitting material located within each of the plurality of linear apertures.

16. The method of claim 15 wherein the applying step comprises:
applying a first voltage potential to the cathode electrode; and
applying a second voltage potential to the gate electrode.

17. An electron emitting structure comprising:
a substrate;
a cathode electrode formed on the substrate, the cathode electrode having linear cathode sections formed in a portion of the cathode electrode;
a gate electrode formed on the substrate, the gate electrode electrically insulated from the cathode electrode, the gate electrode having linear gate sections;
wherein a respective linear cathode section is located in between two respective adjacent linear gate sections; and
an electron emitting material deposited on at least a portion of each of the linear cathode sections.

18. The structure of claim 17 wherein upon applying a voltage potential difference between the cathode electrode and the gate electrode, an electric field is produced across each linear cathode section in between two adjacent linear gate sections sufficient to cause an electron emission from the electron emitting material.

19. The structure of claim 17 wherein the electron emitting material comprises a plurality of electron emitting portions deposited on at least the portion of each of the linear cathode sections.

20. The structure of claim 17 wherein the electron emitting material comprises a continuous electron emitting material deposited as a layer or film on at least the portion of each of the linear cathode sections.

21. The structure of claim 17 wherein the linear cathode sections are defined by linear sections removed from the cathode electrode.

22. The structure of claim 21 wherein the linear gate sections are formed on the substrate within the dimensions of the linear sections defining the linear cathode sections, the linear gate sections not contacting the linear cathode sections.

23. The structure of claim 22 wherein the gate electrode includes a back gate section formed on another surface of the substrate than the linear gate sections, wherein the linear gate sections are electrically coupled to the back gate section.

24. The structure of claim 17 wherein the linear cathode sections and the linear gate sections are formed on a same surface of the substrate.

25. The structure of claim 17 wherein the linear cathode sections are parallel to each other.

26. The structure of claim 17 wherein the linear cathode sections are parallel to the linear gate sections.

27. The structure of claim 17 wherein the linear cathode sections define an active region of the cathode electrode.

28. The structure of claim 17 further comprising:
an anode plate comprising:
a transparent substrate separated above the substrate;
phosphor material coupled to the transparent substrate, the phosphor material for receiving electrons emitted from the electron emitting material in use; and
an anode coupled to the phosphor material for accelerating the electrons toward the phosphor material.

29. A method of electron emission comprising:
applying a voltage potential difference between a cathode electrode formed on a substrate of an electron emitting structure and a gate electrode formed on the substrate, the cathode electrode having linear cathode sections formed in a portion of the cathode electrode, the cathode electrode and the gate electrode separated and electrically insulated from each other, the gate electrode having linear gate sections, wherein a linear cathode section is located in between two adjacent linear gate sections;
producing an electric field across each linear cathode section in between two adjacent linear gate sections as a result of the applying the voltage potential difference; and
causing, as a result of the producing step, an electron emission from an electron emitting material deposited on at least a portion of each of the linear cathode sections.

30. The method of claim 29 wherein the applying step comprises:
applying a first voltage potential to the cathode electrode; and
applying a second voltage potential to the gate electrode.

31. An electron emitting structure comprising:
a substrate;
a cathode electrode formed on a surface of the substrate;
a gate electrode having gate portions formed on the surface of the electrode in a same plane as the cathode electrode;
the substrate electrically insulating the cathode electrode and the gate electrode; and
an electron emitting material deposited on a portion of the cathode electrode.

32. The structure of claim 31 wherein the gate electrode includes a gate section formed on another surface of the substrate, the gate section electrically coupled to the gate portions.
